(19) United States
(12) Patent Application Publication
(10) Pub. No.: US 2024/0380675 A1
(43) Pub. Date: Nov. 14, 2024

(54) SYSTEM AND METHOD FOR PROVISIONING INFORMATION TECHNOLOGY INFRASTRUCTURE USING NARROW ARTIFICIAL INTELLIGENCE

(71) Applicant: SAUDI ARABIAN OIL COMPANY, Dhahran (SA)

(72) Inventors: Qasim T. Zaidi, Dhahran (SA); Sohaib B. Zahran, Dammam (SA)

(21) Appl. No.: 18/316,745

(22) Filed: May 12, 2023

(51) Int. Cl. H04L 41/16; G06F 21/10; H04L 9/40; H04L 41/0806

(52) U.S. Cl. CPC H04L 41/16; G06F 21/105; H04L 41/0806; H04L 63/0823; H04L 63/166

(57) ABSTRACT

A computer-implemented system and method for automatically provisioning an information technology infrastructure. At least one computing device configured by executing instructions processes information associated with prerequisite steps associated with provisioning the information technology infrastructure to determine the prerequisite steps have been previously completed. An operating system of a server computer included in the information technology infrastructure is automatically configured and, using narrow artificial intelligence, automatically validated. Using narrow artificial intelligence, software on the server computer is automatically installed for providing functionality associated with the information technology infrastructure and automatically validated. The at least one computing device automatically configures, using narrow artificial intelligence, the information technology infrastructure, including by configuring the software on the server computer, to complete the provisioning the information technology infrastructure.

### FIELD OF THE DISCLOSURE

The present invention relates, generally, to large-scale computing systems management and, more particularly, to systems and methods provisioning information technology infrastructures.

### BACKGROUND OF THE DISCLOSURE

An information technology (“IT”) infrastructure implemented in server computing devices such as for, for example, multi-user database and electronic mail (“email”) systems, require complex provisioning. Provisioning can include preparing physical and/or virtual computing devices, managing user rights and access to devices and data, configuring network devices and components, and software and data management. Traditional provisioning requires an administrator performing steps manually which is tedious, time-consuming, and prone to errors. Moreover, inconsistent provisioning practices can complicate future maintenance and infrastructure changes.

It is respect to these and other concerns that the present disclosure is made.

### BRIEF SUMMARY

Implementations of the present disclosure include a computer-implemented method and system for automatically provisioning an information technology infrastructure. At least one computing device configured by executing instructions processes information associated with prerequisite steps associated with provisioning the information technology infrastructure, to determine whether prerequisite steps have been previously completed. If not, the at least one computing device using narrow artificial intelligence automatically configures an operating system of a server computer included in the information technology infrastructure. In addition, the at least one computing device using narrow artificial intelligence automatically validates the configuring of the operating system. Moreover, the at least one computing device using narrow artificial intelligence automatically installs software on the server computer for providing functionality associated with the information technology infrastructure. The at least one computing device using narrow artificial intelligence automatically validates the installing of the software on the server computing and automatically configures the information technology infrastructure, including by configuring the software on the server computer, to complete the provisioning the information technology infrastructure.

In one or more implementations of the present disclosure, automatically configuring the software on the server computer comprises automatically submitting, by the at least one computing device using narrow artificial intelligence, at least one product license key, and automatically enabling at least one certificate associated with the information technology infrastructure.

In one or more implementations of the present disclosure, the information technology infrastructure includes an email platform, and further wherein automatically configuring the software on the server computer comprises automatically setting, by the at least one computing device using narrow artificial intelligence, internal and external access uniform resource locators, and automatically configuring at least one authentication protocol.

In one or more implementations of the present disclosure, the information technology infrastructure includes an email platform, and further wherein automatically configuring the software on the server computer comprises automatically validating, by the at least one computing device using narrow artificial intelligence, a transport queue database. Automatically configuring the software further includes automatically configuring transport service limits, logs sharing, and automatically creating automatically dynamic distribution groups.

In one or more implementations of the present disclosure, the information technology infrastructure includes an email platform, and the at least one computing device using narrow artificial intelligence automatically creates at least one database availability group, automatically adds the server computer to the database availability group, and automatically creates at least one mailbox database for the server computer.

In one or more implementations of the present disclosure, the at least one computing device using narrow artificial intelligence automatically adds copies of the at least one mailbox database to at least one other server computer in the database availability group.

In one or more implementations of the present disclosure, the information technology infrastructure includes an email platform, and further wherein configuring the operating system of a server computer included in the information technology infrastructure comprises automatically configuring, by the at least one computing device using narrow artificial intelligence, transport layer security.

In one or more implementations of the present disclosure, automatically configuring the transport layer security comprises automatically disabling, by the at least one computing device using narrow artificial intelligence, a weaker transport layer security version, and automatically enabling, by the at least one computing device using narrow artificial intelligence, a current transport layer security version.

In one or more implementations of the present disclosure, the at least one computing device using narrow artificial intelligence automatically resumes at least one of automatically the operating system, automatically installing the software on the server computer, automatically validating the installing of the software, and the automatically configuring the information technology infrastructure, following an interruption.

These and other features, aspects, and advantages can be appreciated from the following description of certain embodiments in accordance with the present disclosure.

### BRIEF DESCRIPTION OF THE FIGURES

Aspects of the present disclosure will be more readily appreciated upon review of the detailed description of its various embodiments, described below, when taken in conjunction with the accompanying drawings, of which:

FIG. 1 is a simplified block diagram illustrating facilities in an example information technology (“IT”) infrastructure, including hardware facilities and software facilities, in accordance with an example implementation of the present disclosure;

FIG. 2 shows a process flow illustrating example steps that are associated with provisioning an IT infrastructure, in accordance with an example implementation of the present application;

FIG. 3 shows a process flow illustrating example steps that are associated with an example operating system configuration, in accordance with an example implementation of the present application;

FIG. 4 shows a process flow associated with installation procedures, for example, for MICROSOFT EXCHANGE, installation and configuration, in accordance with an example implementation of the present application;

FIG. 5 shows a process flow associated with creation of mailbox databases local to a server, for example, in connection with a MICROSOFT EXCHANGE installation and configuration, in accordance with an example implementation of the present application; and

FIG. 6 shows a process flow associated with creation of adding copies of mailbox databases to one or more other servers, for example, in connection with a MICROSOFT EXCHANGE installation and configuration, in accordance with an implementation of the present disclosure.

### DETAILED DESCRIPTION OF ONE OR MORE EMBODIMENTS

By way of summary and introduction, systems and methods include automatic commissioning of installation and configuration of an IT infrastructure, including as a function of artificial intelligence. In one or more implementations, the present disclosure uses narrow artificial intelligence (“ANI”), in which a learning algorithm completes a discrete task without human assistance. The present disclosure provides improvements in accuracy and efficiency of the many complex and technical operations associated with IT infrastructure installation, configuration and maintenance. Such operations can include automatic execution, validation, and completion, at least partly in response to applied machine learning and artificial intelligence in accordance with existing programming. For example, automation can be developed that is based on one or more previous MICROSOFT EXCHANGE IT infrastructure installations, such as in connection with ACTIVE DIRECTORY domain controller, SQL SERVER(S), email server(s) and other components. Previous IT infrastructure installations and configurations can be used to develop, for example, POWERSHELL scripts, which can be executed in subsequent automatic IT infrastructure procedures, such as MICROSOFT EXCHANGE installation.

One or more graphical user interfaces can be provided in one or more implementations of the present disclosure, including to provide information such as status updates, alerts, and various contextual messages in connection with a respective IT infrastructure installation, configuration, use, maintenance, or other condition. For example, checks on a MICROSOFT EXCHANGE installation and configuration can be automatically performed via processes shown and described herein and responses or information associated with each check can be provided automatically via a user interface to a network or other technical administrator.

In one or more implementations, historic information associated with an in-progress IT infrastructure installation, which may be currently paused or interrupted, is processed via artificial intelligence and used to resume the installation correctly. Appropriately resuming an IT infrastructure installation and/or configuration following termination, including an unexpected termination, can require highly technical analysis and execution of complex operations. Accurate and efficient automation can be provided using the teachings of the present disclosure, thereby reducing costs and the likelihood of errors. Artificial intelligence, smart validation and automatic resumption of processes are effective measures to reduce time and redundancies. Moreover, the systems and methods herein increase installation and maintenance consistency. The use of artificial intelligence in a step-by-step algorithmic approach to IT infrastructure installation, configuration, and maintenance provides an autonomous and self-reliant solution from end to end.

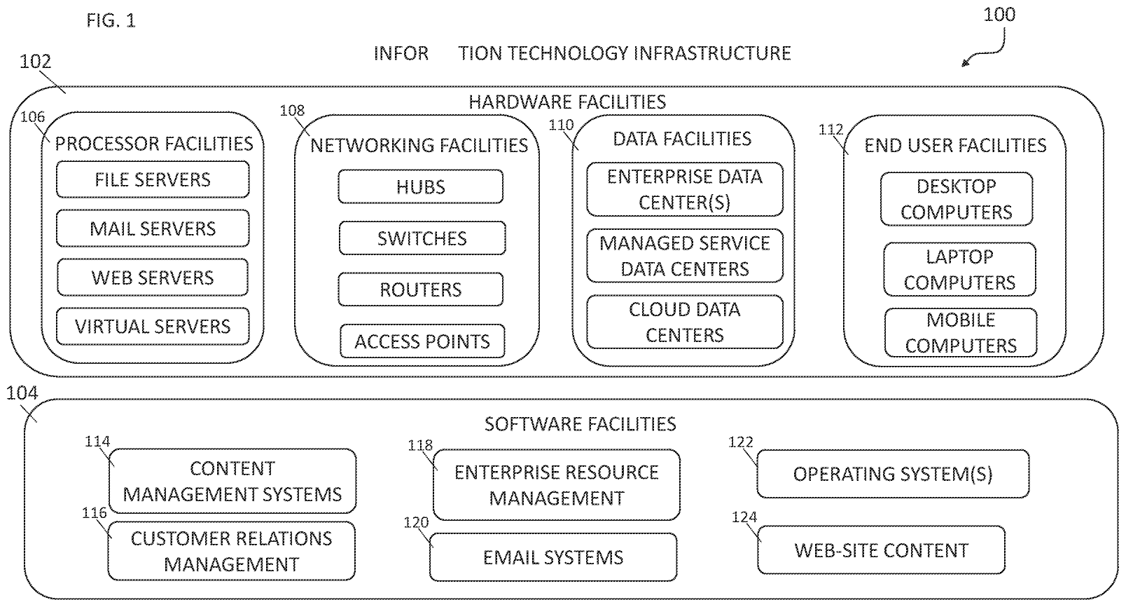

Referring now to a simple block diagram in FIG. 1, an IT infrastructure 100 can include hardware facilities 102 and software facilities 104. Hardware facilities 102 can include, for example, processor facilities 106, network facilities 108, data facilities 110, and end-user facilities 112. Processor facilities 106 can include, for example, file servers, email servers, web servers, and virtual servers. Networking facilities 18 can include, for example, hubs, switches, routers, and access points. Data facilities 110 can include enterprise-wide data centers, managed service data centers, and cloud data centers. End user facilities 112 can include, for example, desktop computers, laptop computers, and mobile computing device (e.g., tablet computing devices and smartphones). Software facilities 104 can include content management systems 114, customer relations management systems 116, enterprise resource management systems 118, email systems 120, operating systems 122, and web-site content 124. These examples illustrate just a few of the many complex and interrelated hardware and software facilities comprised in information technology infrastructures, and the teachings set forth in the present disclosure are applicable to various forms thereof. While the present disclosure includes representative examples of an IT infrastructure comprising hardware and software facilities associated with email, such as MICROSOFT EXCHANGE, it is to be understood and appreciate that the systems and methods set forth herein are effectively applicable in connection with many IT infrastructures and hardware and software facilities associated therewith.

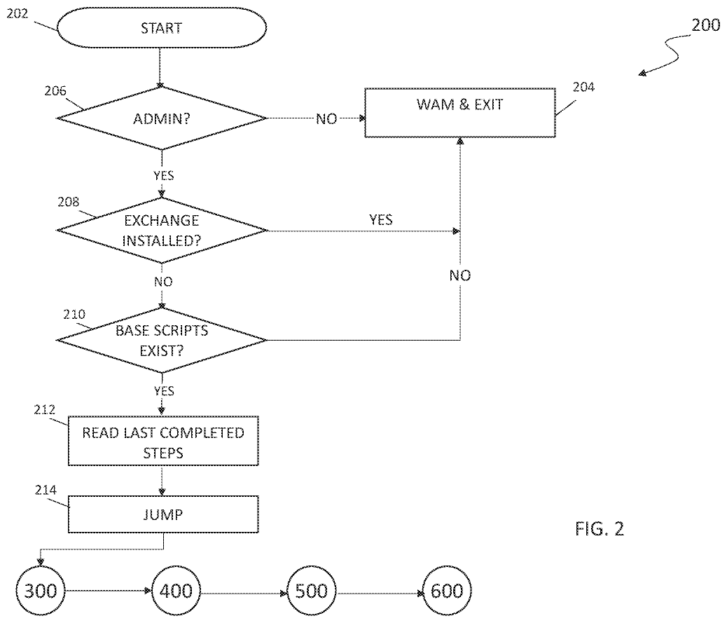

FIG. 2 is a flow chart illustrating an example process 200 including steps that are associated with provisioning an IT infrastructure, in accordance with an example implementation of the present disclosure. It should be appreciated that several of the logical operations described herein are implemented (1) as a sequence of computer implemented acts or program modules running on a communication device and/or (2) as interconnected machine logic circuits or circuit modules within a communication device. The implementation is a matter of choice dependent on the requirements of the device (e.g., size, energy, consumption, performance, etc.). Accordingly, the logical operations described herein are referred to variously as operations, structural devices, acts, or modules. Several of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

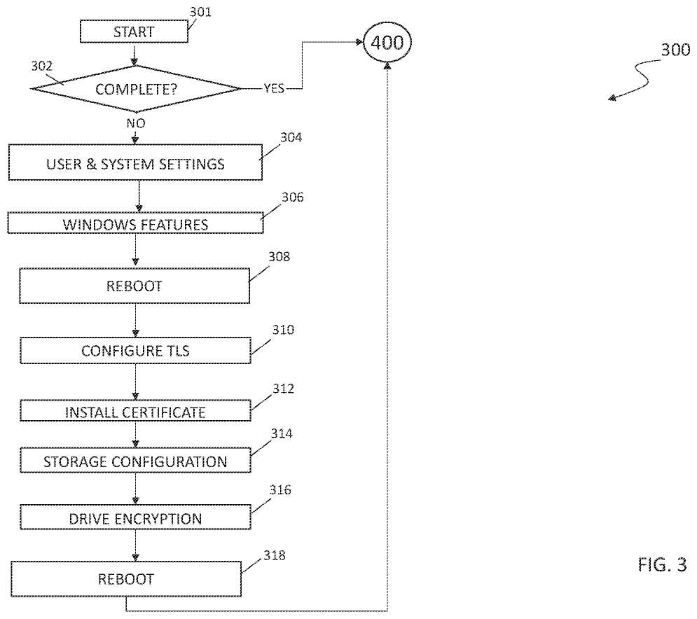

Continuing with reference to FIG. 2, the example IT infrastructure provisioning steps regard an implementation for MICROSOFT EXCHANGE. At step 202, the process starts and a series of prerequisite determinations are made that, depending on the outcome of the determinations, result branching to step 204 for web access management (“WAM”) and exiting of the procedure. For example, at step 206 a determination is made whether a user is logged into the system with administrative rights to proceed. If the determination at step 206 is negative, then the process branches to step 204 and the process ends. Alternatively, if the determination at step 206 is affirmative, then the process continues to step 208 and a determination is made whether the IT infrastructure, in this case MICROSOFT EXCHANGE, is already installed. If the outcome of the determination at step 208 is affirmative, then the process branches to step 204. Alternatively, if the determination at step 208 is negative, then the process branches to step 210 and a determination is made whether base scripts exist. In addition to determining whether base scripts exist, the determination at step 210 can include determining whether extended scripts or MICROSOFT EXCHANGE installation binaries exist. If the result of the determination in step 210 is negative, then the process branches to step 204. Alternatively, if the result of the determination in step 210 is affirmative, then the process branches to step 212 and the most recently (“last”) completed steps are read. System specifications are checked and, thereafter, at step 214, any steps that have been completed can be skipped and the process jumps to one or more of processes 300, 400, 500, and 600, described below and shown in connection with FIGS. 3-6.

Referring now to FIG. 3, process 300 is provided that is associated with an example operating system configuration. At step 301, the process begins and a determination is made at step 302 whether all remaining steps in process 300 are complete. If the result of the determination at step 302 is affirmative, then the process branches to process 400. Alternatively, if the result of the determination at step 302 is negative, then the process branches to step 304. At step 304, for example, user and system settings are checked and recorded. Thereafter, the process continues to step 306 and operating system features, such as features of MICROSOFT WINDOWS, required for the IT infrastructure are installed, the operating system with the added features is validated, and the computing device is rebooted (step 308). Thereafter, the process continues to step 310 and the transport layer security (“TLS”) and one or more network components are configured. For example, weaker TLS versions and ciphers are disabled, newer TLS and network components enabled, and additional network settings, such as internet protocol (“IP”), can be configured. Thereafter, the process continues to step 312 and one or more certificates by the IT infrastructure, in this example MICROSOFT EXCHANGE web services, are installed.

Continuing with reference to FIG. 3, at step 314, storage configuration is performed. For example, storage is configured for a MICROSOFT EXCHANGE mailbox database with mount points. In one or more implementations, storage configuration can include ensuring the configuration is for stress testing of storage drives. Further, a check can be made if the configuration is for a MICROSOFT EXCHANGE installation, and the storage can be formatted and labeled. Thereafter, mount points can be configured. Following the storage configuration at step 314, the process continues to step 316, and drive encryption can be performed. For example, MICROSOFT WINDOWS native BITLOCKER can be used to encrypt one or more storage drives. Thereafter, the computing device reboots at step 318, and the process continues to process 400.

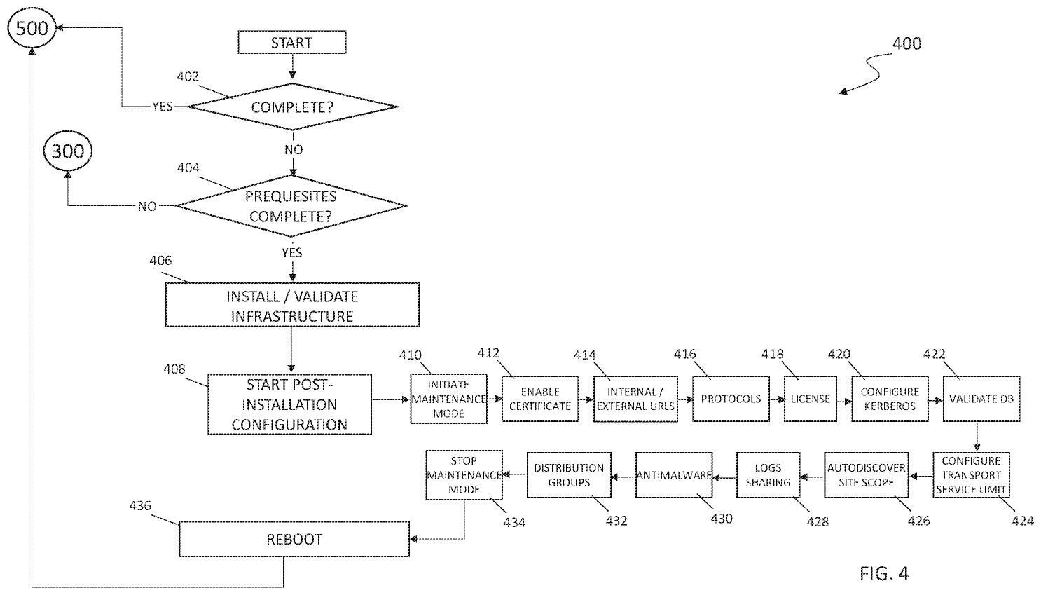

Referring now to FIG. 4, process 400 is provided that is associated with installation procedures, for example, for MICROSOFT EXCHANGE installation and configuration. At step 401, the process starts and a determination is made at step 402 whether all remaining steps in process 400 are complete. If the result of the determination at step 402 is affirmative, then the process branches to process 500. Alternatively, if the result of the determination at step 402 is negative, then the process branches to step 404 and a determination is made whether the prerequisites are valid and complete. If the result of the determination at step 404 is negative, then the process branches to process 300. Alternatively, if the result of the determination at step 404 is positive, then the process branches to step 406 and IT infrastructure installation procedures are initiated. For example, MICROSOFT EXCHANGE installation is implemented as a function of a computing device configured by artificial intelligence to submit programming commands automatically. Thereafter, one or more steps are taken to validate the installation is complete.

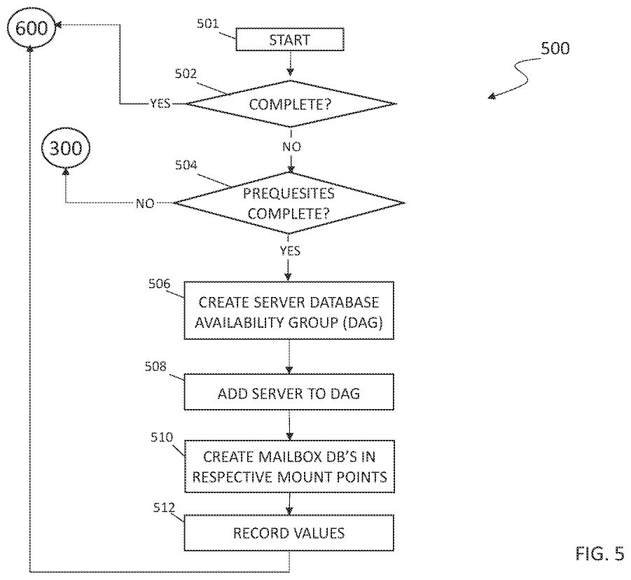

Continuing with reference to the example process 400 shown in FIG. 4, once the IT infrastructure (e.g., MICROSOFT EXCHANGE) is installed in step 406, a series of steps are started to execute automatically to configure the IT infrastructure (step 408). For example, at step 410, one or more server computing devices is placed in maintenance mode. At step 412, a digital certificate, such as a MICROSOFT EXCHANGE certificate, is enabled. At step 414, one or more commands are executed automatically to set uniform resource locators (“URLs”) for internal and external access. At step 416, one or more protocols, such as MICROSOFT EXCHANGE protocols, are configured to start automatically. At step 418, product license information is automatically provided. At 420, one or more network authentication protocols, such as KERBEROS authentication, is configured. At step 422, one or more commands automatically execute to validate a MICROSOFT EXCHANGE transport queue database. In addition, transport service limits are configured (step 424), as is an AutodiscoverSiteScope parameter (step 426). Other configuring can include log sharing (step 428), configuring an antimalware engine proxy (step 430), and creating dynamic distribution groups for the local server (step 432). After the configuring steps are complete, maintenance mode can be stopped (step 434), and the process continues to step 436 where the computing device reboots. Thereafter the process continues to process 500 (FIG. 5).

Referring now to FIG. 5, process 500 is provided that is associated with creation of mailbox databases local to a server, for example, in connection with a MICROSOFT EXCHANGE installation and configuration. At step 501, the process starts and a determination is made at step 502 whether all remaining steps in process 500 are complete. If the result of the determination at step 502 is affirmative, then the process branches to process 600. Alternatively, if the result of the determination at step 502 is negative, then the process branches to step 504 and a determination is made whether the prerequisites are valid and complete. If the result of the determination at step 504 is negative, then the process branches to process 300. Alternatively, if the result of the determination at step 504 is positive, then the process branches to step 506 and a server's database availability group (DAG) is created. Thereafter, the server is added to the DAG (step 508), mailbox databases are created in respective mount points (step 510), and respective values representing the databases and mount points are recorded (step 512) and the process continues to process 600.

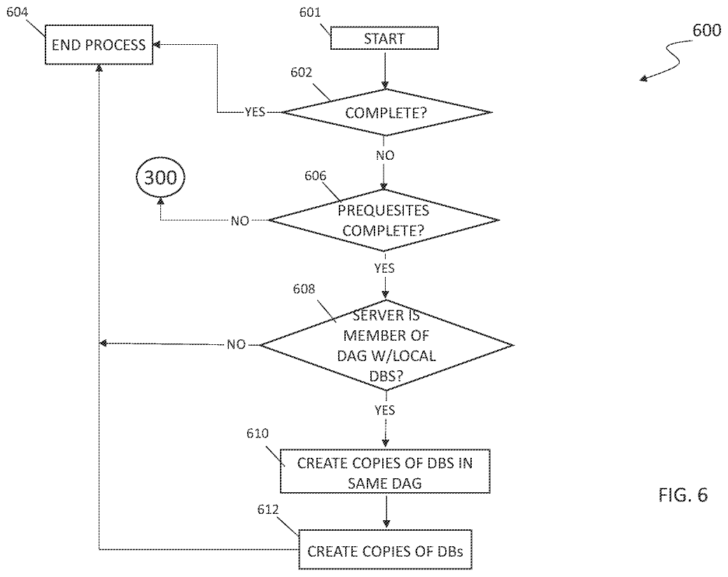

Referring now to FIG. 6, process 600 is provided that is associated with creation of adding copies of mailbox databases to one or more other servers, for example, in connection with a MICROSOFT EXCHANGE installation and configuration. At step 601, the process starts and a determination is made at step 602 whether all remaining steps in process 600 are complete. If the result of the determination at step 602 is affirmative, then the process branches to step 604 and the process ends. Alternatively, if the result of the determination at step 602 is negative, then the process branches to step 606 and a determination is made whether the prerequisites are valid and complete. If the result of the determination at step 606 is negative, then the process branches to process 300. Alternatively, if the result of the determination at step 606 is positive, then the process branches to step 608 and a determination is made that the server to receive a copy of the mailbox database is a member of the database availability group as the server. If the result of the determination at step 608 is negative, then the process branches to step 604 and the process ends. Alternatively, if the result of the determination at step 608 is affirmative, then the process branches to step 610 and copies of the mailbox database(s) are added to servers that are members of the same database availability group. Thereafter, the process continues to step 604 and the process ends.

Accordingly, the present disclosure provides systems and methods for automating installation and configuration of an IT infrastructure. Narrow artificial intelligence can be employed in accordance with the present disclosure, including a step-by-step algorithmic approach that provides full autonomy without human interaction or involvement. Moreover, slight modifications to provisioning an IT infrastructure can be implemented, such as by removing any pausing following completion of a respective step.

Moreover, human error and manual steps can be eliminated by the features shown and described herein, and efficiency is markedly. Validation of completed steps that were performed automatically by one or more computing devices via narrow artificial intelligence ensures accuracy and improves provisioning IT infrastructure in the enterprise. Still further, monitoring and recording processes and completed steps, IT infrastructure provisioning provided in accordance with the present disclosure can be automatically restarted or continued from a given point in the process, such as following an unintentional or intentional interruption. Here again, a need for system administrators to monitor, execute, restart, and complete steps associated with IT infrastructure provisioning is eliminated.

The terms “a,” “an,” and “the,” as used in this disclosure, means “one or more,” unless expressly specified otherwise.

The term “communicating device.” as used in this disclosure, means any hardware, firmware, or software that can transmit or receive data packets, instruction signals or data signals over a communication link. The hardware, firmware, or software can include, for example, a telephone, a smart phone, a personal data assistant (PDA), a smart watch, a tablet, a computer, a software defined radio (SDR), or the like, without limitation.

The terms “computer” or “computing device.” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a server farm, a computer cloud, or the like, or an array of processors, microprocessors, central processing units, general purpose computers, super computers, personal computers, laptop computers, palmtop computers, notebook computers, desktop computers, workstation computers, servers, or the like, without limitation.

The term “computer-readable medium.” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, Wi-Fi, WiMAX, IEEE 802.11, DECT, 0G, 1G, 2G, 3G, 4G, or 5G cellular standards, Bluetooth, or the like.

The terms “transmission” and “transmit,” as used in this disclosure, refer to the conveyance of signals via electricity, acoustic waves, light waves and other electromagnetic emissions, such as those generated in connection with communications in the radio frequency (RF) or infrared (IR) spectra. Transmission media for such transmissions can include coaxial cables, copper wire and fiber optics, including the wires that comprise a system bus coupled to the processor.

The term “database,” as used in this disclosure, means any combination of software and/or hardware, including at least one application and/or at least one computer. The database can include a structured collection of records or data organized according to a database model, such as, for example, but not limited to at least one of a relational model, a hierarchical model, a network model or the like. The database can include a database management system application (DBMS) as is known in the art. The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including.” “comprising” and variations thereof, as used in this disclosure, mean “including, but not limited to,” unless expressly specified otherwise.

The term “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which can be configured to communicate data via a wireless and/or a wired communication medium. These networks can run a variety of protocols not limited to TCP/IP, IRC or HTTP.

The term “server,” as used in this disclosure, means any combination of software and/or hardware, including at least one application and/or at least one computer to perform services for connected clients as part of a client-server architecture. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any of its computers, can also be used as a workstation.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, including as indicated by a respective reference numeral, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

The present disclosure has been described with reference to the accompanying drawings, which form a part hereof, and which show, by way of illustration, example implementations. As such, the figures and examples above are not meant to limit the scope of the present disclosure to a single implementation, as other implementations are possible by way of interchange of some or all of the described or illustrated elements, without departing from the spirit of the present disclosure. Among other things, for example, the disclosed subject matter can be embodied as methods, devices, components, or systems.

Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

Furthermore, it is recognized that terms used herein can have nuanced meanings that are suggested or implied in context beyond an explicitly stated meaning. Likewise, the phrase “in one implementation” as used herein does not necessarily refer to the same embodiment and the phrase “in one or more implementations” as used herein does not necessarily refer to different implementations. It is intended, for example, that claimed subject matter can be based upon combinations of individual example implementations, or combinations of parts of individual example implementations.

The foregoing description of the specific implementations will so fully reveal the general nature of the disclosure that others can, by applying knowledge within the skill of the relevant art(s) (including the contents of the documents cited and incorporated by reference herein), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown of drawings are shown according to one example and other dimensions can be used without departing from the present disclosure.

While various implementations of the present disclosure have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described example implementations, and the disclosure is to be understood as being defined by the recitations in the claims which follow and structural and functional equivalents of the features and steps in those recitations.

1. A computer-implemented method for automatically provisioning an information technology infrastructure, the method comprising:
processing, by at least one computing device configured by executing instructions, information associated with prerequisite steps for provisioning a Microsoft Exchange information technology infrastructure, including an Active Directory domain controller, at least one Microsoft SQL server computer, and at least one Microsoft Exchange server computer, to determine the prerequisite steps;
automatically configuring, by the at least one computing device using narrow artificial intelligence, an operating system of a Microsoft Exchange server computer included in the information technology infrastructure;
automatically validating, by the at least one computing device using narrow artificial intelligence, the configured operating system;
automatically installing, by the at least one computing device using narrow artificial intelligence, software on the Microsoft Exchange server computer for providing functionality associated with the information technology infrastructure, including by:
automatically validating, using narrow artificial intelligence, a transport queue database;
automatically configuring, using narrow artificial intelligence, transport service limits;
automatically configuring, using narrow artificial intelligence, logs sharing; and
automatically creating, using narrow artificial intelligence, dynamic distribution groups;
automatically validating, by the at least one computing device using narrow artificial intelligence, the software installed on the Microsoft Exchange server computer; and
automatically configuring, by the at least one computing device using narrow artificial intelligence, the information technology infrastructure, including by configuring the software on the Microsoft Exchange server computer, to complete the provisioning the Microsoft Exchange information technology infrastructure,
wherein, as a function of the narrow artificial intelligence, operations including the automatically configuring the operating system, the automatically validating the configured operating system, the automatically installing the software on the Microsoft Exchange server computer, the automatically validating the software installed, and the automatically configuring the Microsoft Exchange information technology infrastructure occur without pause or interruption.

2. The method of claim 1, wherein automatically configuring the software on the Microsoft Exchange server computer comprises:
automatically submitting, by the at least one computing device using narrow artificial intelligence, at least one product license key; and
automatically enabling, by the at least one computing device using narrow artificial intelligence, at least one certificate associated with the Microsoft Exchange information technology infrastructure.

3. The method of claim 1, wherein automatically configuring the software on the Microsoft Exchange server computer comprises:
automatically setting, by the at least one computing device using narrow artificial intelligence, internal and external access uniform resource locators; and
automatically configuring, by the at least one computing device using narrow artificial intelligence, at least one authentication protocol.

4. (canceled)

5. The method of claim 1, further comprising:
automatically creating, by the at least one computing device using narrow artificial intelligence, at least one database availability group;
automatically adding, by the at least one computing device using narrow artificial intelligence, the Microsoft Exchange server computer to the database availability group; and
automatically creating, by the at least one computing device using narrow artificial intelligence, at least one mailbox database for the Microsoft Exchange server computer.

6. The method of claim 5, further comprising:
automatically adding, by the at least one computing device using narrow artificial intelligence, copies of the at least one mailbox database to a Microsoft SQL server computer in the database availability group.

7. The method of claim 1, wherein configuring the operating system of the Microsoft Exchange server computer included in the information technology infrastructure comprises:
automatically configuring, by the at least one computing device using narrow artificial intelligence, transport layer security.

8. The method of claim 7, wherein automatically configuring the transport layer security comprises:
automatically disabling, by the at least one computing device using narrow artificial intelligence, a weaker transport layer security version; and
automatically enabling, by the at least one computing device using narrow artificial intelligence, a current transport layer security version.

9. (canceled)

10. A computer-implemented system for automatically provisioning an information technology infrastructure, the system comprising:
at least one computing device, wherein the at least one computing device is configured by executing instructions to:
process information associated with prerequisite steps for provisioning a Microsoft Exchange information technology infrastructure, including an Active Directory domain controller, at least one Microsoft SQL server computer, and at least one Microsoft Exchange server computer, to determine the prerequisite steps;
automatically configure, using narrow artificial intelligence, an operating system of a Microsoft Exchange server computer included in the information technology infrastructure;
automatically validate, by the at least one computing device using narrow artificial intelligence, the configuring of the configured operating system;
automatically install, using narrow artificial intelligence, software on the Microsoft Exchange server computer for providing functionality associated with the information technology infrastructure, including by:
automatically validating, using narrow artificial intelligence, a transport queue database;
automatically configuring, using narrow artificial intelligence, transport service limits;
automatically configuring, using narrow artificial intelligence, logs sharing; and
automatically creating, using narrow artificial intelligence, dynamic distribution groups;
automatically validate, using narrow artificial intelligence, the installing of the software on the Microsoft Exchange server computer; and
automatically configure, using narrow artificial intelligence, the Microsoft Exchange information technology infrastructure, including by configuring the software on the Microsoft Exchange server computer, to complete the provisioning the information technology infrastructure,
wherein, as a function of the narrow artificial intelligence, operations including the automatically configuring the operating system, the automatically validating the configured operating system, the automatically installing the software on the Microsoft Exchange server computer, the automatically validating the software installed, and the automatically configuring the Microsoft Exchange information technology infrastructure occur without pause or interruption.

11. The system of claim 10, wherein the at least one computing device is further configured by executing instructions for automatically configuring the software on the Microsoft Exchange server computer to:
automatically submit, using narrow artificial intelligence, at least one product license key; and
automatically enable, using narrow artificial intelligence, at least one certificate associated with the Microsoft Exchange information technology infrastructure.

12. The system of claim 10, wherein the at least one computing device is further configured by executing instructions for configuring the software on the Microsoft Exchange server computer to:
automatically set, using narrow artificial intelligence, internal and external access uniform resource locators; and
automatically configure, using narrow artificial intelligence, at least one authentication protocol.

13. (canceled)

14. The system of claim 10, wherein the at least one computing device is further configured by executing instructions to:
automatically create, using narrow artificial intelligence, at least one database availability group;
automatically add, using narrow artificial intelligence, the Microsoft Exchange server computer to the database availability group; and
automatically create, using narrow artificial intelligence, at least one mailbox database for the Microsoft Exchange server computer.

15. The system of claim 14, and further wherein the at least one computing device is further configured by executing instructions to:
automatically add, using narrow artificial intelligence, copies of the at least one mailbox database to a Microsoft SQL server computer in the database availability group.
